(19) United States
(12) Patent Application Publication
(10) Pub. No.: US 2015/0302415 A1
(43) Pub. Date: Oct. 22, 2015

(54) TRANSACTION ROUTING BASED ON CUSTOMER PREFERENCE AND SOCIAL CONTACT MANAGEMENT

(71) Applicant: Craig Harold Reines, Mercer Island, WA (US)

(72) Inventor: Craig Harold Reines, Mercer Island, WA (US)

(21) Appl. No.: 14/690,211

(22) Filed: Apr. 17, 2015

Related U.S. Application Data
(60) Provisional application No. 61/981,618, filed on Apr. 18, 2014.

(51) Int. Cl. G06Q 30/00; G06Q 10/10; H04L 29/06

(52) U.S. Cl. CPC G06Q 30/016; H04L 65/1069; G06Q 10/1095

(57) ABSTRACT

The subject matter disclosed herein establishes a communication connection between a customer and an employee of the customer's choosing based on user defined customer interaction preferences. One or more customer interaction preferences associated with a customer may be accessed. One or more employee profiles may be accessed. Each employee profile may be associated with a different employee and may have one or more employee attributes. A computing device may be caused to display a subset of the employee profiles. The subset of the employee profiles may have at least one employee attribute that matches at least one of the customer interaction preferences. Data representative of a selection of at least one employee from the subset of employee profiles may be received from the computing device. A communication connection may be established between the customer and the selected employee. Related apparatus, systems, techniques, and articles are also described.

### CROSS REFERENCE TO RELATED APPLICATION

This application claims priority under 35 U.S.C. §119(e) to U.S. Provisional Patent Application No. 61/981,618, filed on Apr. 18, 2014, titled “Transaction Routing Based On Customer Preference And Social Contact Management”, the disclosure of which is herein incorporated by reference in its entirety.

### TECHNICAL FIELD

This disclosure relates generally to customer contact routing technologies and, in particular, to the selection of an employee, such as a customer service representative, from a list of eligible employees based on any customer interaction preferences provided by the customer.

### BACKGROUND

Current customer contact routing technologies may be considered linear, uni-directional systems that connect waiting customers to the next, best, and available employee, agent, or automated attendant. Generally, a customer may interact through an open communication channel first (for example, a telephone call, an email/message, a digital portal, a virtual/physical storefront, and the like). The customer may be required to go through an initial triage stage (for example, identification of issue, preferred language method, inquiry type, and the like) which may be processed programmatically by an automated attendant (with or without human assistance). The outcome of the triage may establish the interaction path or route for the transaction. Where no triage occurs, the customer may be placed on a fixed path or route which is pre-defined by the communication channel. However, all routes may terminate at a physical or virtual address which is associated with an individual employee, a collection of employees, a static message and/or an automated attendant. The only choice a customer may have may be limited to a fixed number of options on a dual-tone multi-frequency signaling system or a speech-enabled interactive voice response system. These conventional customer contact routing technologies may be implemented using static business driven rules, with little or no customer preference or involvement.

### SUMMARY

Methods and apparatus, including computer program products, are provided for enabling a customer to select an employee, such as a customer service representative, based on one or more user defined customer interaction preferences and establishing a communication connection between the customer and the selected employee.

In one aspect, one or more customer interaction preferences associated with a customer are accessed. One or more employee profiles are accessed. Each of the one or more employee profiles is associated with a different employee and has one or more employee attributes. A computing device is caused to display a subset of the one or more employee profiles. The subset of the one or more employee profiles has at least one employee attribute that matches at least one of the one or more customer interaction preferences. Data representative of a selection of at least one employee from the subset of the one or more employee profiles is received from the computing device. A communication connection is established between the customer and the selected at least one employee using a desired contact type.

The above methods, apparatus, and computer program products may, in some implementations, further include one or more of the following features.

The display of the subset of the one or more employee profiles may further include an availability of each employee.

The one or more customer interaction preferences may be associated with one or more weights. One or more scores may be calculated for the subset of the one or more employee profiles using the one or more weights. The display of the subset of the one or more employee profiles may be sorted based on the one or more scores.

The establishing the communication connection between the customer and the selected at least one employee may include one or more of initiating a phone call, initiating a conference call, initiating a live chat, initiating a video call, and initiating an in-person interaction.

The establishing the communication connection between the customer and the selected at least one employee may include scheduling an appointment for a future date and a future time when the selected employee is not available.

A rating may be received after the communication connection is terminated. The employee profile associated with the at least one employee selected by the customer may be updated using the received rating.

The contact type may include one or more of a phone call, a conference call, a live chat, a video call, and an e-mail.

The one or more customer interaction preferences may further include one or more of the desired contact type, a desired language, a desired location, a desired minimum rating, and a desired service.

The subset of the one or more employee profiles may have at least one employee attribute that matches all of the one or more customer interaction preferences.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIG. 1 illustrates a system architecture for establishing a connection with an employee based on one or more customer interaction preferences, in accordance with some example implementations;

FIG. 2A illustrates a home screen of a customer service application, in accordance with some example implementations;

FIGS. 2B, 2C, 2D, 2E, 2F, and 2G illustrate graphical user interfaces associated with the customer service application, in accordance with some example implementations;

FIG. 3 illustrates an employee profile, in accordance with some example implementations;

FIG. 4A illustrates a graphical user interface that includes a list of eligible employees, in accordance with some example implementations;

FIG. 4B illustrates a graphical user interface that indicates that a selected employee is busy, in accordance with some example implementations;

FIG. 4C illustrates a graphical user interface for scheduling an appointment with a busy or an unavailable employee, in accordance with some example implementations;

FIG. 5 illustrates a graphical user interface for soliciting feedback from a customer, in accordance with some example implementations; and

FIG. 6 illustrates a process for establishing a connection with an employee based on one or more customer interaction preferences, in accordance with some example implementations.

Like reference symbols in the various drawings indicate like elements.

### DETAILED DESCRIPTION

Implementations of the disclosed subject matter provide techniques that enable a customer to establish his/her own unique set of contact preferences/business rules. The customer may be presented employee profiles to contact for resolution of their support, service, or sales transaction. The customer may thus dictate the manner by which their service interaction follows including the interaction channel or contact method that they prefer and the time, place, and with whom they interact with. These techniques may be used in any service routing environment where an individual requests helps from an employee, such as a call center, a brick and mortar retail store, a health care facility (e.g., scheduling walk-in appointments at a hospital), a government agency (e.g., scheduling road tests at the Department of Motor Vehicles based on employee access to handicap accessible vehicles), and the like. These techniques may be used to route employee resources, phone calls, chat requests, e-mails, conference calls, tweets, instant messages, Voice over IP messages, and the like to an employee of the customer's choosing.

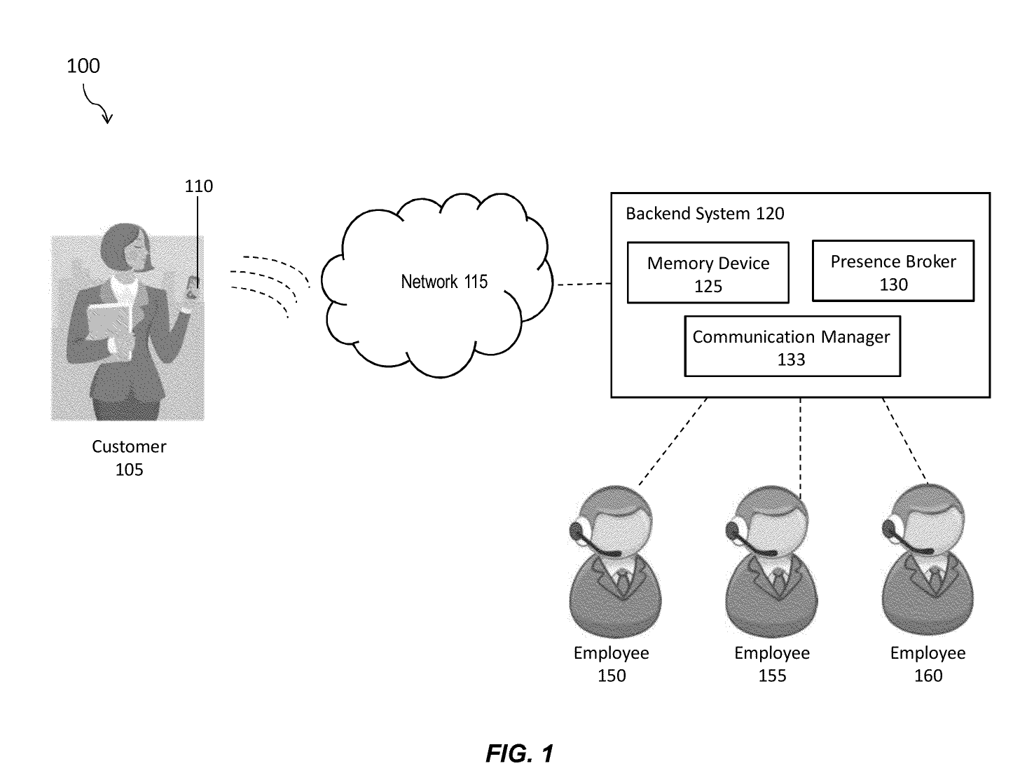

FIG. 1 illustrates a system 100 for implementing the techniques disclosed herein. System 100 includes a customer 105 and a computing device 110. Customer 105 may use computing device 110 to launch and use a customer service application. Although computing device 110 is illustrated as a mobile phone in the implementation of FIG. 1, other types of computing devices may be used including, for example, a laptop computer, a tablet computer, a desktop computer, a public terminal (such as a self service kiosk or video terminal), and the like. Customer 105 may use the customer service application to designate his/her customer interaction preferences and to select an employee from a tailored list of eligible employees in order to initiate a customer service interaction.

The customer service application may reside locally on computing device 110 or may be remotely accessed from backend system 120. Backend system 120 may be a customer relationship management system, for example. Backend system 120 may include a memory device 125 and a presence broker 130. Memory device 125 may be a computer data storage device, such as random access memory, electrically erasable programmable read-only memory, and the like. Memory device 125 may store data records used by the customer service application including, for example, customer interaction preferences associated with one or more customers (such as customer 105) and employee profiles associated with one or more employees (such as employees 150, 155, and 160). Presence broker 130 may comprise at least one processor and may process requests for customer service. As explained in detail below, presence broker 130 may receive a request for customer service from the customer service application running on computing device 110. In response to this request, presence broker 130 may compile a list of eligible employees.

Backend system 120 may also include a communication manager 133. Communication manager 133 may comprise at least one processor and may establish a communication connection between customer 105 and an employee of the customer's choosing. The communication connection may use any communication technology that is currently available or may become available in the future. In doing so, communication manager 133 may, for example, initiate a phone call, a conference call, a live chat, a video call, and the like between customer 105 and a selected employee. In some implementations, communication manager 133 may exchange one or more e-mails between customer 105 and the selected employee, exchange one or more messages to schedule an appointment between the customer and the selected employee, and the like. While communication manager 133 is illustrated as a separate device in the implementation of FIG. 1, other configurations are possible. For example, communication manager 133 and presence broker 130 may be consolidated within a single device.

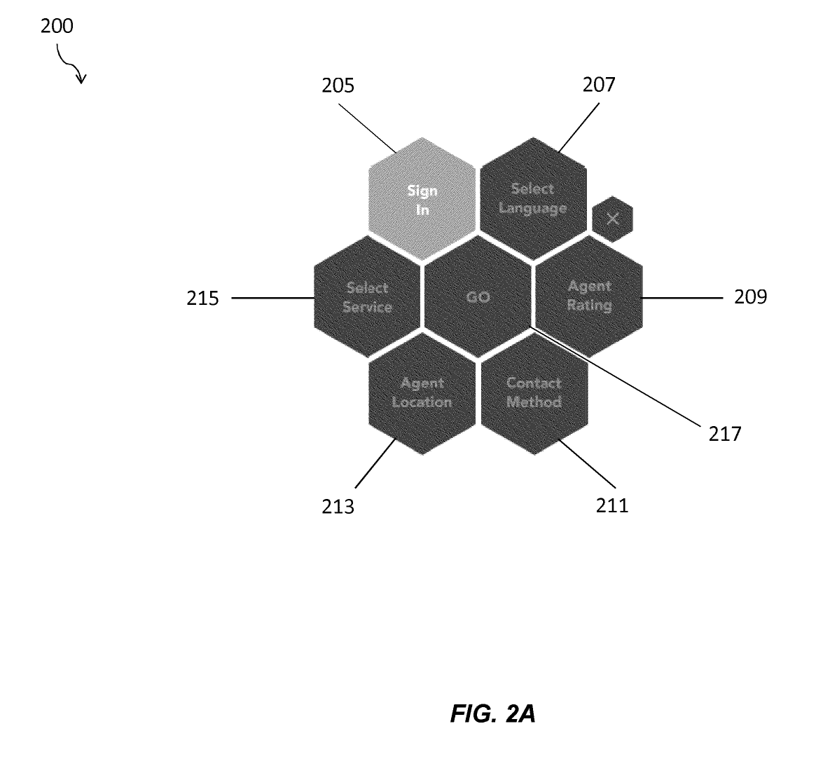

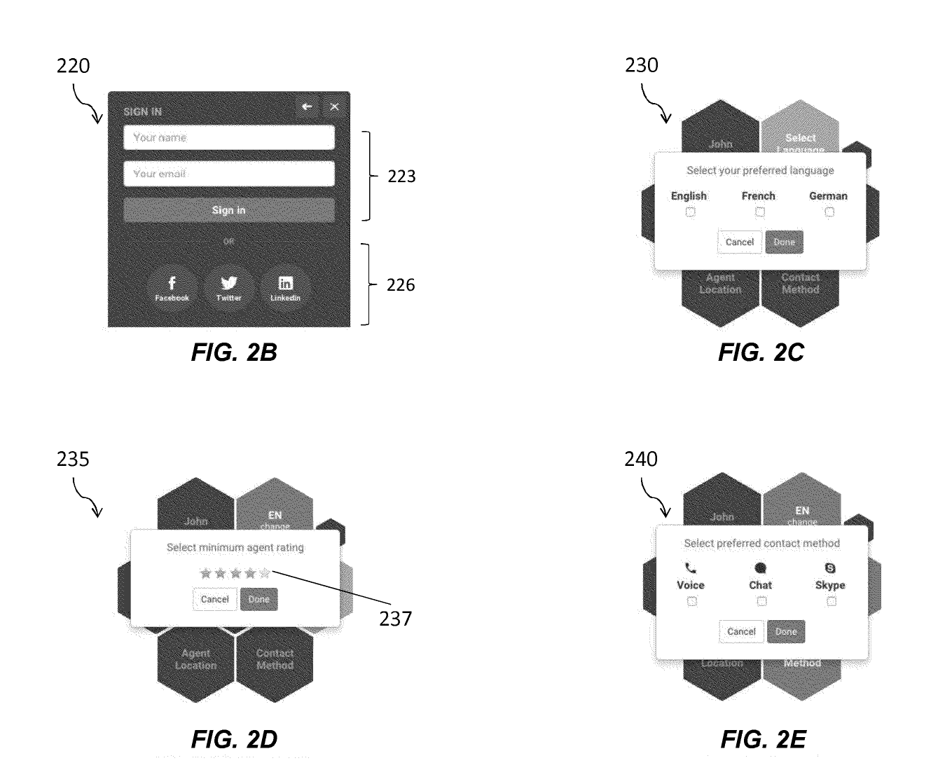

FIG. 2A illustrates a home screen 200 of the customer service application. Customer 105 may use home screen 200 to sign into the customer service application (using option 205) and designate his/her customer interaction preferences. Various customer interaction preferences may be used including, for example, a desired language 207, a desired agent rating 209, a desired contact method 211, a desired agent location 213, and a desired service 215. Customer 105 may set any number and any combination of customer interaction preferences or none at all. These customer interaction preferences may be saved locally at computing device 110 or remotely at memory device 125. In the latter configuration, computing device 110 may send the customer interaction preferences to backend system 120 periodically or upon the occurrence of a trigger event (e.g., as customer 105 designates customer interaction preferences). The sign in process and the designation of customer interaction preferences are described below with respect to FIGS. 2B, 2C, 2D, 2E, 2F, and 2G.

FIG. 2B illustrates a graphical user interface 220 for signing into the customer service application. The customer service application may display graphical user interface 220 when sign in 205 is selected from FIG. 2A. In the implementation of FIG. 2B, two sign in options 223 and 226 are available. In option 223, customer 105 may sign into the customer service application using his/her name and e-mail address. The customer service application may send this information to backend system 120 to authenticate customer 105. In option 226, customer 105 may sign into the customer service application using a preexisting social media account, such as Facebook®, Twitter®, Linkedin®, and the like. It should be understood that sign in options 223 and 226 are merely exemplary, and that any authentication method may be used to verify the customer's identity including, for example, biometric authentication, challenge-response authentication, and the like. The customer service application may prompt customer 105 to sign in each time he/she launches the application. In some implementations, a customer's sign in information may be saved to computing device 110 and/or backend system 120. Saving sign in information may allow customer 105 to bypass the process illustrated in FIG. 2B after he/she successfully signs in a first time.

FIG. 2C illustrates a graphical user interface 230 for selecting a preferred language for the customer service interaction. The customer service application may display graphical user interface 230 when select language 207 is selected from FIG. 2A. Customer 105 may use graphical user interface 230 to designate the desired language abilities of a customer service representative. For example, if customer 105 wishes to speak with an employee in English, then he/she may insert a check mark in the appropriate box. Customer 105 may designate one or more preferred languages. In some implementations, customer 105 may not designate any preferred language. Omitting a selection merely removes this customer interaction preference when searching for eligible employees. While the implementation of FIG. 2C only lists English, French, and German as possible preferred languages, any number of languages may be included. In some implementations, graphical user interface 230 may provide an input area for customer 105 to add one or more languages not explicitly provided in FIG. 2C. Customer 105 may select “Done” to finalize these language selections. If customer 105 is unhappy with these selections, he/she may select “Cancel” to return to home screen 200.

FIG. 2D illustrates a graphical user interface 235 for selecting a minimum agent rating. The customer service application may display graphical user interface 235 when agent rating 209 is selected from FIG. 2A. Setting the minimum agent rating may be helpful in designating a minimum level of competence as measured by customer ratings. In the implementation of FIG. 2D, a four star minimum agent rating 237 is selected. Based on this selection, presence broker 130 may only select employees having a four star rating or a five star rating. Employees having a one star rating, a two star rating, or a three star rating may be eliminated from consideration. An employee's rating may be determined from a set of numerical ratings assigned by customers, managers, colleagues, and the like. The agent rating may correspond to an average rating or a median rating, for example. Although the implementation of FIG. 2D is based on a maximum five star rating, any number of stars, points, and other measures of competence may be used including, for example, a rating based on a number or percentage of resolved customer issues, a rating based on a number or percentage of customer complaints, and the like. Customer 105 may select “Done” to finalize the minimum agent rating selection. If customer 105 is unhappy with this selection, he/she may select “Cancel” to return to home screen 200.

FIG. 2E illustrates a graphical user interface 240 for selecting a preferred contact method. The customer service application may display graphical user interface 240 when contact method 211 is selected from FIG. 2A. Designating the preferred contact method allows customer 105 to select the preferred medium of communication. If, for example, customer 105 wishes to participate in a voice call with an employee, then he/she may insert a check mark in the appropriate box. Customer 105 may select zero, one, or more than one preferred contact method. While the implementation of FIG. 2E only lists voice, chat, and Skype®, other contact methods may be used including, for example, video calls, in-person meetings, e-mail, paper correspondence, and the like. FIG. 2E may be agnostic to the communication technologies that are currently available or may become available in the future. Customer 105 may select “Done” to finalize these contact method selections. If customer 105 is unhappy with these selections, he/she may select “Cancel” to return to home screen 200.

FIG. 2F illustrates a graphical user interface 245 for selecting an agent location. The customer service application may display graphical user interface 245 when agent location 213 is selected from FIG. 2A. Selecting an agent location may be useful if, for example, customer 105 is trying to set up an in-person meeting with an employee at a local store. Customer 105 may select zero locations, one location, or more than one location. While the implementation of FIG. 2F only has options available for New York, California, and an option to select any location, other geographic regions may be included. The customer service application may populate graphical user interface 245 with locations based on the customer's recent travel history or based on the customer's current location. The customer's current location may be determined using, for example, a geopositioning application residing on computing device 110 or from historical data stored at memory device 125. In some implementations, graphical user interface 245 may provide an input area for customer 105 to add locations not explicitly provided in FIG. 2F. Customer 105 may select “Done” to finalize these agent location selections. If customer 105 is unhappy with these selections, he/she may select “Cancel” to return to home screen 200.

FIG. 2G illustrates a graphical user interface 250 for designating one or more desired services. The customer service application may display graphical user interface 250 when select service 215 is selected from FIG. 2A. Customer 105 may use graphical user interface 250 to enter the services or areas that he/she needs assistance with. For example, if customer 105 has a smartphone related question, he/she may enter “Smartphone” into graphical user interface 250. In another example, if customer 105 is trying to schedule a walk-in appointment at a hospital to treat physical discomfort in his/her eyes, he/she may enter “burning eyes” into graphical user interface 250. Upon doing so, graphical user interface 250 may present the user entered words as a service tag 253. Presence broker 130 may use service tags 253 to search for employees with relevant experience or expertise. In some implementations, the customer service application may propose additional service tags 253 that are relevant to the user entered service tag. These proposals may be based on words or phrases that are commonly searched together. The customer service application may access these commonly searched words or phrases from the Internet or from a predefined list locally saved to computing device 110 or backend system 120, for example. In the implementation of FIG. 2G, the customer service application may propose “wifi,” “data,” and “help” as additional service tags 253 because these words are often searched with “Smartphone.” Customer 105 may delete an undesired service tag 253 by selecting the “X” button on the service tag. Customer 105 may select “Search” to finalize his/her selection of desired services.

Once customer 105 is satisfied with his/her selection of customer interaction preferences (or chooses not to select any at all), he/she may finalize the selected preferences. In the implementation of FIGS. 2A and 2G, for example, customer 105 may do so by selecting “Go” option 217 or “Search” option 255, respectively. In some implementations, “Go” or “Search” options and the like may be accessed from any of graphical user interfaces 220, 230, 235, 240, 245, and 250. Upon receiving an indication that these customer interaction preferences have been finalized, the customer service application may send a request to presence broker 130 to search for eligible employees. This request may include the finalized customer interaction preferences. In some implementations, the customer interaction preferences may already be saved to memory device 125, in which case presence broker 130 may directly access these preferences.

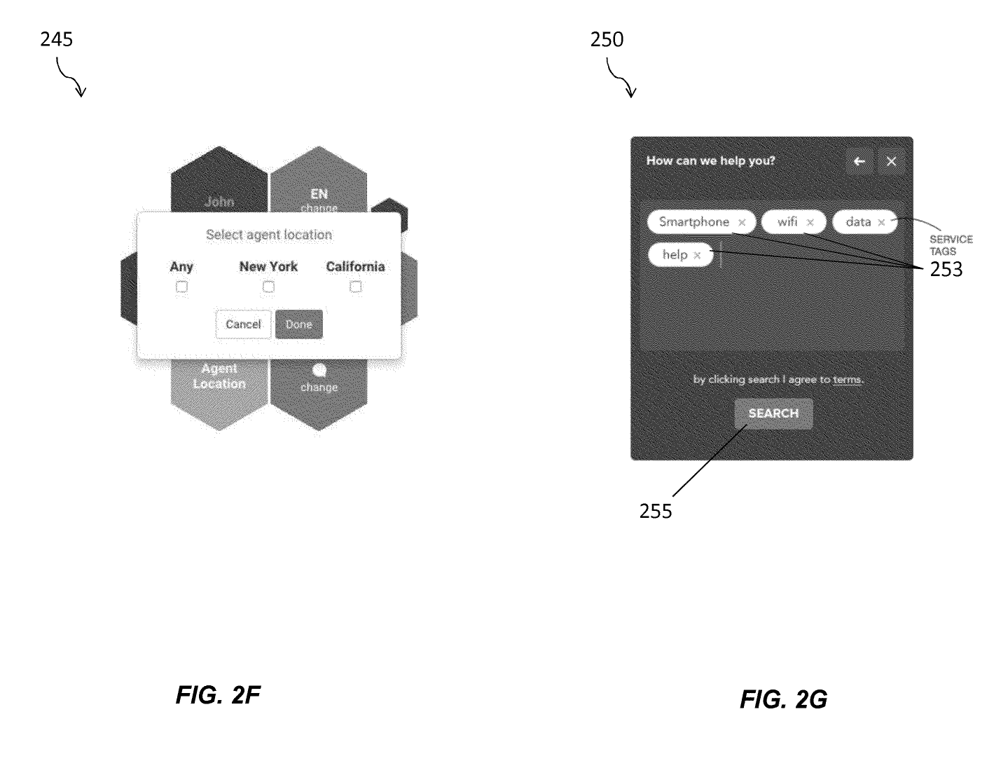

FIG. 3 illustrates an exemplary employee profile 300. Memory device 125 may store one or more employee profiles 300, and each profile may be associated with a different employee. For example, each of employees 150, 155, and 160 may have his/her own employee profile 300. Employee profile 300 may store various attributes associated with the employee including, for example, the employee's name 305 (“James Smith”), title or position 310 (“Senior Support Person”), language 315 (“English, French”), agent rating 320 (four stars), contact method 325 (“Call”), location 330 (“San Francisco”), and service or expertise 335 (“Smartphone”). An employee may access his/her profile 300 to change one or more of these attributes. For example, if James Smith is only available by chat, then he/she may adjust contact method 325 from “Call” to “Chat.” In some implementations, presence broker 130 may automatically adjust one or more attributes. For example, if James Smith was recently promoted, presence broker 130 may automatically change title or position 310 from “Senior Support Person” to James' new title. Some attributes, however, may not be changed by the employee including, for example, agent rating 320. As explained above with respect to FIG. 2D, the agent rating may be determined from a set of numerical ratings assigned by customers, managers, colleagues, and the like.

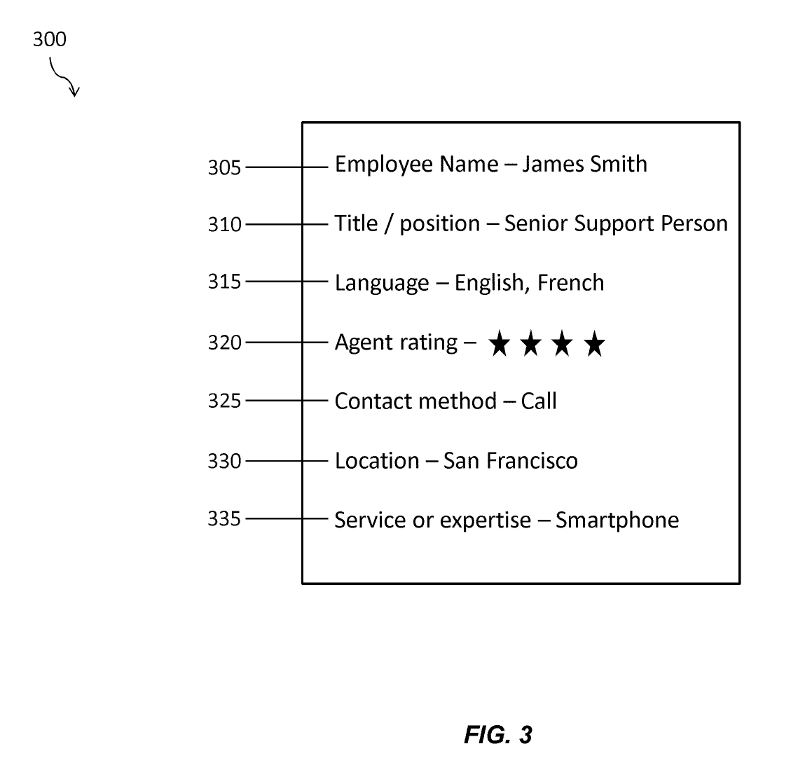

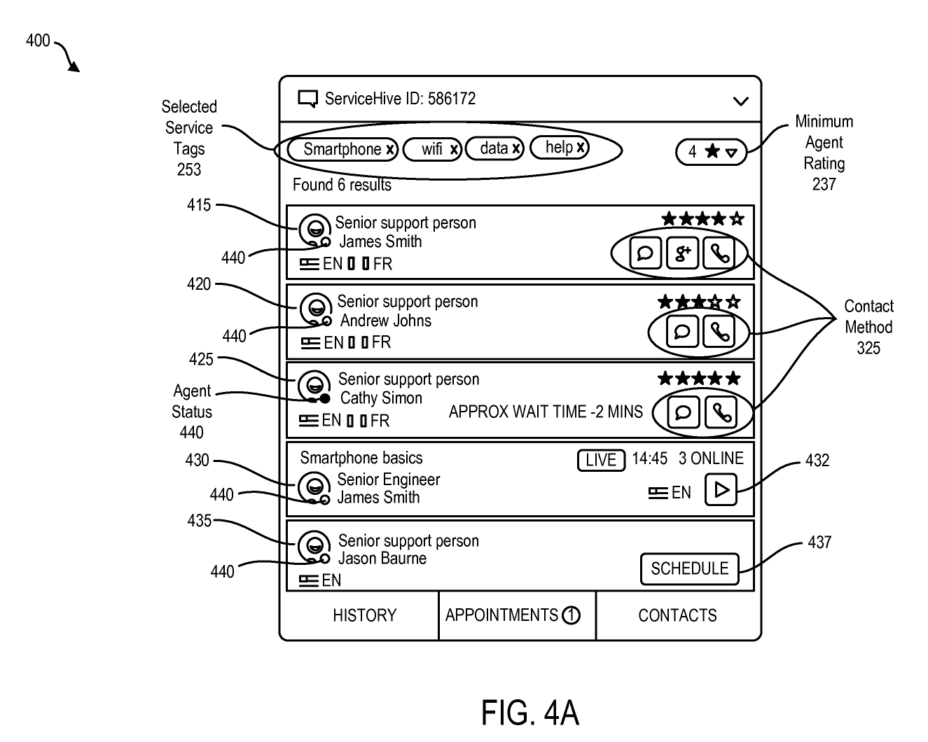

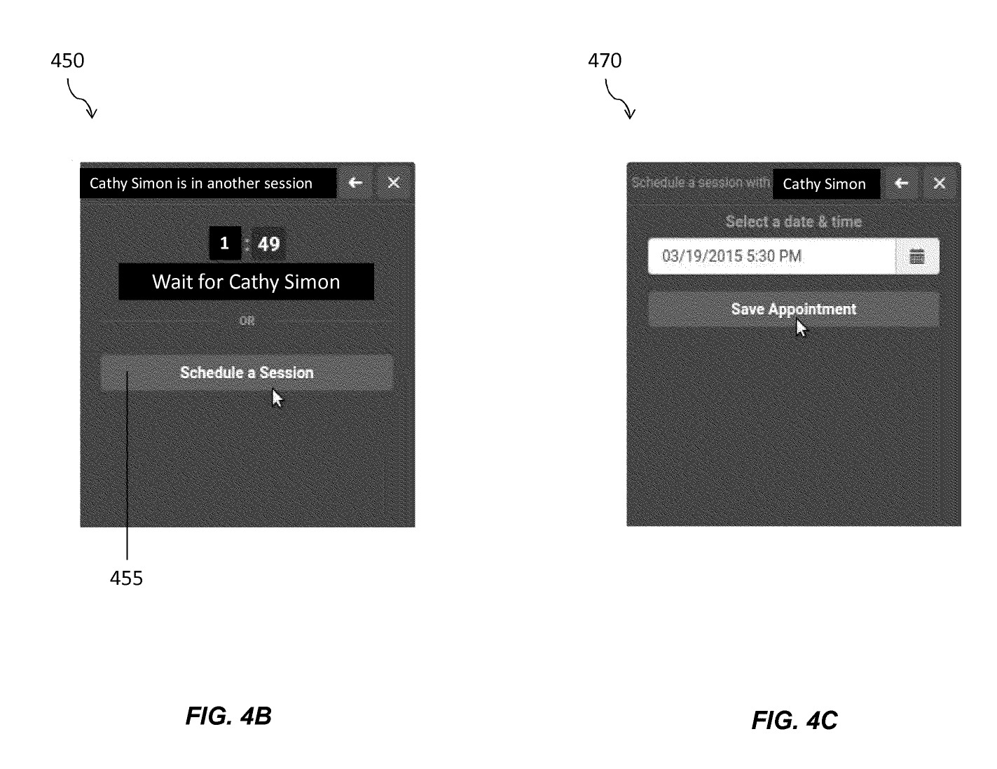

FIG. 4A illustrates a graphical user interface 400 that includes a list of eligible employees resulting from the presence broker's search. Presence broker 130 may generate this list by matching the selected customer interaction preferences with attributes in one or more employee profiles 300. As described above, customer 105 may set various customer interaction preferences including, for example, a desired language, a desired minimum agent rating, a desired contact method, a desired location, and a desired service. Presence broker 130 may match these customer interaction preferences with the corresponding attributes in employee profiles 300. Presence broker 130 may create a list of eligible employees based on this matching process and cause computing device 110 to display this list. In some scenarios, customer 105 may not designate any values for any customer interaction preferences if none are desired. In these cases, presence broker 130 may generate an unfiltered list of all employees. In some implementations, this unfiltered list may include only available employees.

This list may include only those employees that are an exact match with the customer interaction preferences or any employee having at least one matching attribute. For example, if customer 105 designates an English language speaking employee (i.e., a desired language) based in New York (i.e., a desired agent location) with experience repairing refrigerators (i.e., a desired service) as his/her customer interaction preferences, then presence broker 130 may search employee profiles 300 for these attributes. In some implementations, customer 105 may assign weights to the customer interaction preferences to emphasize those factors most important to the customer. For example, if customer 105 is more interested in finding an employee with refrigerator repair experience than an English speaking employee in New York, then he/she may assign a high weight to the desired service (e.g., 10) and a low weight to the desired language (e.g., 1) and desired agent location (e.g., 1). Although the weights in this example are based on a numerical range between 1 and 10, any numerical scoring system can be used. Presence broker 130 can use these weights to score employee profiles 300. Continuing with the above example, if Employee A has refrigerator repair experience (which has a weight of 10), then presence broker 130 may assign a 10 as this employee's profile score. If Employee B speaks English (which has a weight of 1) and resides in New York (which has a weight of 1) but has no refrigerator repair experience, then presence broker 130 may assign a 2 as this employee's profile score. Presence broker 130 may then cause computing device 110 to display these employee profiles in a prioritized list based on their scores. Because Employee A may have a higher profile score than Employee B, then Employee A's profile may be presented before Employee B's profile. The relative position of these profiles may indicate that Employee A is a closer match to the customer interaction preferences than Employee B.

Presence broker 130 may prioritize or sort this list of eligible employees in other ways. For example, the employee with the most matching attributes may be presented first; the employee with the second most matching attributes may be presented second; and so on. The list of employees may also be prioritized based on employee availability, for example. In these implementations, available employees may be presented before busy or unavailable employees, for example. If, however, the presence broker 130 is unable to find any eligible employees, then it may display a message indicating the same. In some implementations, the presence broker 130 may also display suggestions for removing, adding, and/or changing one or more customer interaction preferences if no matches are found. These changes may improve the search results. For example, if “IPv6” is entered as a desired service in graphical user interface 250 and there are no employee profiles with this expertise, then presence broker 130 may propose a closely related alternative, such as “IP”. This closely related alternative may be based on similar words or phrases entered by the customer. In another example, if “Cantonese” is entered as a desired language 207 and there are no employee profiles with the desired language skills, then presence broker 130 may suggest a closely related alternative, such as “Mandarin”. This closely related alternative may be based on the similarities between the languages.

Graphical user interface 400 may include minimum agent rating 237 (as described above with respect to FIG. 2D) and service tags 253 (as described above with respect to FIG. 2G). Customer 105 may adjust minimum agent rating 237 and service tags 253 directly from graphical user interface 400. For example, customer 105 may broaden the search by removing the “wifi” service tag 253 and decreasing the minimum agent rating 237 to three stars. Upon doing so, presence broker 130 may update its search using these new values and refresh the list of eligible employees.

In the implementation of FIG. 4A, presence broker 130 may determine that employees having abbreviated profiles 415, 420, 425, 430, and 435 are the best eligible candidates based on the matching process described above. Each abbreviated profile may include various attributes including, for example, the employee's name, position, language abilities, agent rating, and available contact methods. Presence broker 130 may generate abbreviated profiles 415, 420, 425, 430, and 435 using the information in employee profiles 300. In some implementations, these abbreviated profiles may correspond to the full employee profiles 300 illustrated in FIG. 3. Each abbreviated profile 415, 420, 425, 430, and 435 may include an agent status 440 that indicates the employee's availability. Agent status 440 may change appearance depending on whether an employee is currently available, busy (e.g., supporting another customer), or otherwise unavailable. For example, agent status 440 may be green (as with abbreviated records 415 and 420), yellow (as with abbreviated record 425), or red (as with abbreviated records 430 and 435) depending on whether the employee is available, busy but available soon, or unavailable, respectively. Presence broker 130 may have access to each employee's schedule and may update agent status 440 using these schedules. Presence broker 130 may update agent status 440 in real time (i.e., on a continuous basis) or on a periodic basis (e.g., every 5 minutes).

After reviewing abbreviated profiles 410, 420, 425, 430, and 435, customer 105 may select an employee to interact with. Any employee may be selected regardless of his/her agent status 440. As such, customer 105 may select an available, busy, or unavailable employee. As explained below, communication manager 133 may establish a communication connection between customer 105 and the selected employee.

Customer 105 may initiate a customer service interaction with any available employee. In the implementation of FIG. 4A, James Smith (senior support person corresponding to abbreviated record 415) and Andrew Johns (corresponding to abbreviated record 420) may be currently available as indicated by their green agent status 440. Customer 105 may initiate contact with either employee by selecting the desired contact method 325 from abbreviated profiles 415 and 420. Presence broker 130 may receive this selection from computing device 110 and send a message to communication manager 133 indicating the same. This message may cause communication manager 133 to establish a communication connection between customer 105 and the selected employee using the selected contact method. In some implementations, communication manager 133 may receive data representative of this selection directly from computing device 110. For example, communication manager 133 may receive a message from computing device 110 indicating that the phone icon in abbreviated profile 415 has been selected. Upon receiving this message, communication manager 133 may check James Smith's availability (corresponding to abbreviated record 415) for a phone call by asking presence broker 130, for example. If James Smith (corresponding to abbreviated record 415) is available, then communication manager 133 may initiate a phone call by calling the customer from James Smith's phone, calling James Smith from the customer's phone, setting up a conference line for James Smith and the customer and alerting both parties of the conference line, and the like.

Customer 105 may also initiate a customer service interaction with busy employees. In the implementation of FIG. 4A, Cathy Simon (corresponding to abbreviated record 425) may be busy as indicated by her yellow agent status 440. Abbreviated record 425 may optionally display an indication of when the employee is expected to become available. For example, abbreviated record 425 may include a countdown timer that displays the approximate wait time. If customer 105 wishes to initiate contact with Cathy Simon, he/she may do so by selecting the desired contact method 325 from abbreviated profile 425. Upon doing so, presence broker 130 may cause the customer service application to display graphical user interface 450 illustrated in FIG. 4B. Graphical user interface 450 may include an updated countdown timer that displays the estimated wait time. Upon expiration of the timer, communication manager 133 may establish a communication connection between customer 105 and Cathy Simon using the selected contact method 325. For example, if the live chat option is selected, then communication manager 133 may initiate a chat session between customer 105 and Cathy Simon by opening chat windows on both parties' computing devices.

If, however, customer 105 prefers to schedule a session rather than wait, he/she may do so by selecting “Schedule a Session” 455 which, in turn, may cause the customer service application to display graphical user interface 470 illustrated in FIG. 4C. Customer 105 may select a date and time and save the appointment. In some implementations, customer 105 may also select a contact method for the appointment from graphical user interface 470. The customer service application may send the appointment date and time and selected contact method to communication manager 133 for scheduling. In some implementations, presence broker 130 and/or communication manager 133 may insert the appointment date and time directly into the employee's calendar. The customer service application may also set one or more alarms on computing device 110 to remind customer 105 of the upcoming appointment. This alarm may be activated at any predetermined time before the appointment (e.g., 24 hours before the appointment). In some implementations, communication manager 133 may send a confirmation message to computing device 110 to finalize the appointment date and time after determining that the employee has no conflicting appointments. At the designated appointment date and time, the communication manager 133 may establish a communication connection between customer 105 and the employee using the selected contact method.

Customer 105 may also initiate a customer service interaction with unavailable employees. In the implementation of FIG. 4A, Jason Bourne (corresponding to abbreviated record 435) may be unavailable as indicated by his red agent status 440. If customer 105 wishes to schedule an appointment with Jason Bourne, he/she may do so by selecting “Schedule” option 437. Upon doing so, the customer service application may display graphical user interface 470. Customer 105 may use graphical user interface 470 to schedule an appointment in the same manner as described above with respect to FIG. 4C. The customer service application may send the appointment date and time to presence broker 130 and/or communication manager 133 for scheduling into the employee's calendar.

In the implementations described above, customer 105 may initiate a one-on-one interaction with an employee. Other types of interactions are available. For example, customer 105 may join a group conversation. In the implementation of FIG. 4A, for example, James Smith (senior engineer corresponding to corresponding to abbreviated record 430) may be leading a live chat with 3 participants. These other participants may include additional customers, additional employees, or any combination thereof. Customer 105 may join this group conversation by selecting play option 432.

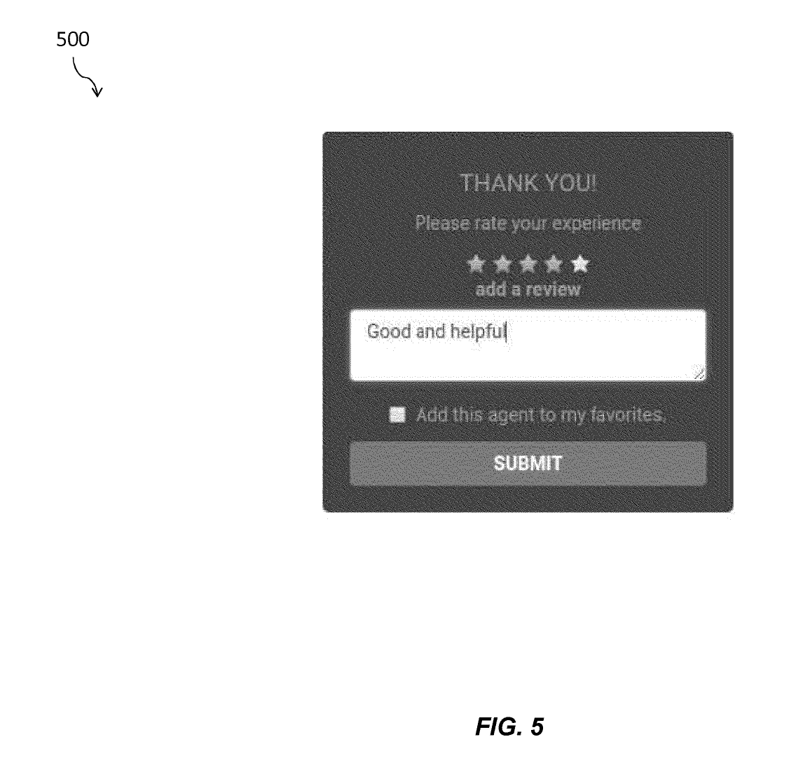

At the end of a customer session or when the communication connection is terminated, the customer service application may display graphical user interface 500 illustrated in FIG. 5. Graphical user interface 500 may prompt customer 105 to provide feedback by rating the employee and/or the session. This rating may be saved to memory device 125 and may result in an updated agent rating 320. Customer 105 may also add a review or add the employee to a list of favorite agents. In some implementations, the customer service application may ask customer 105 if he/she wishes to find a different customer service representative. The customer service application may do so if customer 105 provides a low rating (e.g., three stars or less), for example.

The following illustrative examples describe different applications of the subject matter disclosed herein.

### Example 1

A customer may be completing a consumer loan application at their local financial institution branch and may have several questions. There is a long wait time to speak with a physically present financial service employee. Utilizing the system of FIG. 1, the customer may select from other qualified, matching employee personnel that are currently available in other locations. The customer may communicate via video, voice or text-based communications instantly to complete the transaction and meet any physical identification or “know your customer” requirements that the bank may have without needing to travel to another physical location.

### Example 2

A customer may be having a technical problem with their recently purchased laptop computer and may request assistance using the customer service application. In doing so, the customer may establish the following customer interaction preferences:
Language: English
Contact Type: Voice call
Skill/Expertise required: Laptop and Notebook technical support
Minimum agent rating: [symbol] (5/5 Stars)

Presence broker 130 may determine that there are no currently available employees having the desired minimum agent rating of 5/5 Stars. Presence broker 130, however, may list alternate profiles that most closely match the customer interaction preferences. One of the alternate profiles may be an employee that has a minimum agent rating of 3 stars and is currently in a group/community support interaction with two other customers that are having the same technical support problem. The customer may choose to join the in-progress group voice interaction.

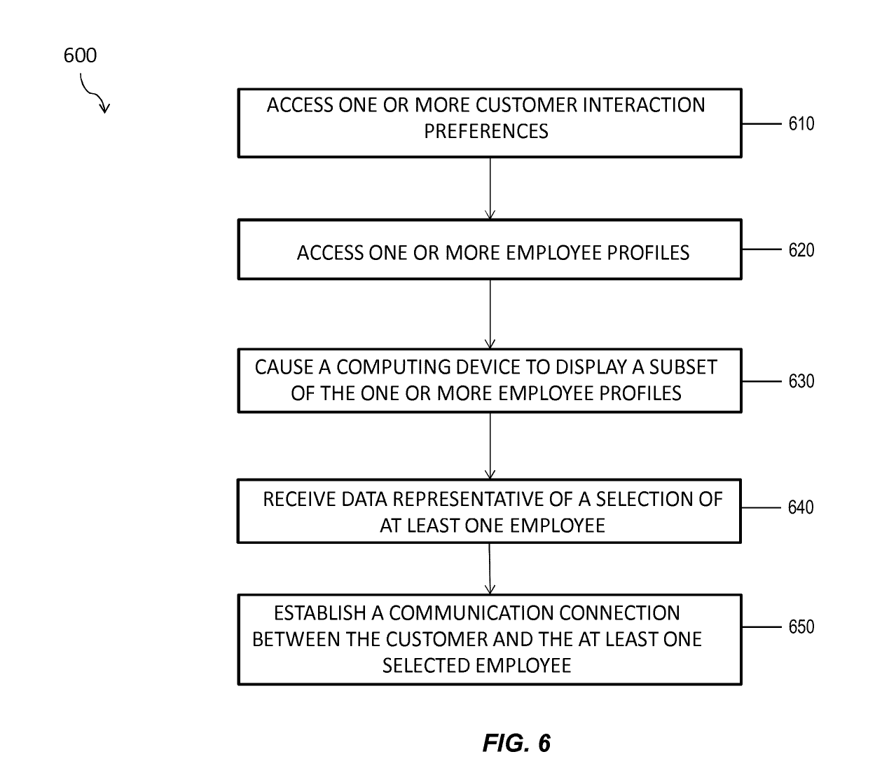

FIG. 6 illustrates a flowchart 600 for establishing a connection with an employee based on one or more customer interaction preferences consistent with the subject matter disclosed herein.

At 610, a presence broker comprising at least one processor may access one or more customer interaction preferences. A customer, such as customer 105, may designate these customer interaction preferences using the graphical user interfaces illustrated in FIGS. 2B, 2C, 2D, 2E, 2F, and 2G. In some implementations, a customer may choose not to designate any values for any customer interaction preferences. Customer 105 may use computing device 105 to send any designated customer interaction preferences directly to the presence broker. Additionally or alternatively, these customer interaction preferences may be saved to memory device 125, and the presence broker may access these preferences from the memory device.

At 620, the presence broker may access one or more employee profiles. These employee profiles may correspond to employees 150, 155, and 160, for example. FIG. 3 illustrates an exemplary employee profile 300. Each employee profile may include various attributes, such as an employee service. This employee service may correspond to the employee's expertise 335.

At 630, the presence broker may cause a computing device, such as computing device 110, to display a subset of the employee profiles. This subset of employee profiles may correspond to the abbreviated profiles illustrated in FIG. 4A. The subset of employee profiles may have at least one employee attribute that matches at least one customer interaction preference.

At 640, the presence broker may receive data representative of a selection of at least one employee. In the implementation of FIG. 4A, for example, computing device 110 may send a message to the presence broker indicating that customer 105 wishes to start a live chat with Andrew Johns. The presence broker may, in turn, send information regarding the same to communication manager 133. In some implementations, communication manager 133 may receive this data directly from computing device 110. In some implementations, communication manager 133 and the presence broker may be the same device.

At 650, the communication manager may establish a communication connection between the customer and the selected employee using a desired contact type. Continuing with the example described above at 640, the communication manager may initiate a live chat between customer 105 and Andrew Johns by opening chat windows on both parties' computing devices.

One or more aspects or features of the subject matter described herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which may also be referred to as programs, software, software applications, applications, components, or code, include machine instructions for a programmable processor, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein may be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

Other implementations may be within the scope of the following claims.

What is claimed is:

1. A computer-implemented method comprising:
accessing, by at least one processor, one or more customer interaction preferences associated with a customer;
accessing, by at least one processor, one or more employee profiles, each of the one or more employee profiles associated with a different employee and having one or more employee attributes;
causing, by at least one processor, a computing device to display a subset of the one or more employee profiles, the subset of the one or more employee profiles having at least one employee attribute that matches at least one of the one or more customer interaction preferences;
receiving from the computing device, by at least one processor, data representative of a selection of at least one employee from the subset of the one or more employee profiles; and
establishing, by at least one processor, a communication connection between the customer and the selected at least one employee using a desired contact type.

2. The computer-implemented method of claim 1, wherein the display of the subset of the one or more employee profiles further includes an availability of each employee.

3. The computer-implemented method of claim 1, wherein the one or more customer interaction preferences are associated with one or more weights,
wherein the causing further comprises calculating one or more scores for the subset of the one or more employee profiles using the one or more weights, and
wherein the display of the subset of the one or more employee profiles is sorted based on the one or more scores.

4. The computer-implemented method of claim 1, wherein the establishing the communication connection between the customer and the selected at least one employee comprises one or more of initiating a phone call, initiating a conference call, initiating a live chat, initiating a video call, and initiating an in-person interaction.

5. The computer-implemented method of claim 1, wherein the establishing the communication connection between the customer and the selected at least one employee comprises scheduling, by at least one processor, an appointment for a future date and a future time when the selected at least one employee is not available.

6. The computer-implemented method of claim 1 further comprising:
receiving, by at least one processor, a rating after the communication connection is terminated; and
updating, by at least one processor, the employee profile associated with the at least one employee selected by the customer using the received rating.

7. The computer-implemented method of claim 1, wherein the contact type includes one or more of a phone call, a conference call, a live chat, a video call, and an e-mail.

8. The computer-implemented method of claim 1, wherein the one or more customer interaction preferences further includes one or more of the desired contact type, a desired language, a desired location, a desired minimum rating, and a desired service.

9. The computer-implemented method of claim 1, wherein the subset of the one or more employee profiles has at least one employee attribute that matches all of the one or more customer interaction preferences.

10. A non-transitory computer-readable medium containing instructions to configure a processor to perform operations comprising:
accessing one or more customer interaction preferences associated with a customer;
accessing one or more employee profiles, each of the one or more employee profiles associated with a different employee and having one or more employee attributes;
causing a computing device to display a subset of the one or more employee profiles, the subset of the one or more employee profiles having at least one employee attribute that matches at least one of the one or more customer interaction preferences;
receiving from the computing device data representative of a selection of at least one employee from the subset of the one or more employee profiles; and
establishing a communication connection between the customer and the selected at least one employee using a desired contact type.

11. The non-transitory computer-readable medium of claim 10, wherein the display of the subset of the one or more employee profiles further includes an availability of each employee.

12. The non-transitory computer-readable medium of claim 10, wherein the one or more customer interaction preferences are associated with one or more weights,
wherein the causing further comprises calculating one or more scores for the subset of the one or more employee profiles using the one or more weights, and
wherein the display of the subset of the one or more employee profiles is sorted based on the one or more scores.

13. The non-transitory computer-readable medium of claim 10, wherein the establishing the communication connection between the customer and the selected at least one employee comprises one or more of initiating a phone call, initiating a conference call, initiating a live chat, initiating a video call, and initiating an in-person interaction.

14. The non-transitory computer-readable medium of claim 10, wherein the establishing the communication connection between the customer and the selected at least one employee comprises scheduling an appointment for a future date and a future time when the selected at least one employee is not available.

15. The non-transitory computer-readable medium of claim 10, wherein the subset of the one or more employee profiles has at least one employee attribute that matches all of the one or more customer interaction preferences.

16. A system comprising:
at least one processor; and
at least one memory, wherein the at least one processor and the at least one memory are configured to perform operations comprising:
accessing one or more customer interaction preferences associated with a customer;
accessing one or more employee profiles, each of the one or more employee profiles associated with a different employee and having one or more employee attributes;
causing a computing device to display a subset of the one or more employee profiles, the subset of the one or more employee profiles having at least one employee attribute that matches at least one of the one or more customer interaction preferences;
receiving from the computing device data representative of a selection of at least one employee from the subset of the one or more employee profiles; and
establishing a communication connection between the customer and the selected at least one employee using a desired contact type.

17. The system of claim 16, wherein the display of the subset of the one or more employee profiles further includes an availability of each employee.

18. The system of claim 16, wherein the one or more customer interaction preferences are associated with one or more weights,
wherein the causing further comprises calculating one or more scores for the subset of the one or more employee profiles using the one or more weights, and
wherein the display of the subset of the one or more employee profiles is sorted based on the one or more scores.

19. The system of claim 16, wherein the establishing the communication connection between the customer and the selected at least one employee comprises one or more of initiating a phone call, initiating a conference call, initiating a live chat, initiating a video call, and initiating an in-person interaction.

20. The system of claim 16, wherein the subset of the one or more employee profiles has at least one employee attribute that matches all of the one or more customer interaction preferences.
